(19) United States
(12) Patent Application Publication
(10) Pub. No.: US 2010/0141156 A1
(43) Pub. Date: Jun. 10, 2010

(54) FLOWER POT INCORPORATING LIGHTS FOR ILLUMINATING PLANTS

(75) Inventors: Serafino Canino, Torrington, CT (US); Scott Gelormino, Burlington, CT (US)

Correspondence Address: THOMPSON HINE L.L.P.;Intellectual Property Group, P.O. BOX 8801, DAYTON, OH, 45401-8801, US

(73) Assignee: ICC INNOVATIVE CONCEPTS CORPORATION, Canton, CT (US)

(21) Appl. No.: 12/354,938

(22) Filed: Jan. 16, 2009

Related U.S. Application Data
(63) Continuation-in-part of application No. 12/330,390, filed on Dec. 8, 2008.

(51) Int. Cl. H05B 37/02; F21V 33/00; H05B 39/02

(52) U.S. Cl. 315/154; 362/154; 315/313

(57) ABSTRACT

A flowerpot including structure for illuminating a plant or other object or objects contained within the flowerpot may comprise a container. At least one light is supported on the container. A power source is coupled to the at least one light. The container may define an upper circumferential rim. The at least one light may be supported proximate the upper circumferential rim. If desired, a plurality of lights may be disposed at spaced intervals about the circumferential rim.

### CROSS REFERENCE TO RELATED APPLICATIONS

This application is a continuation in part of co-pending U.S. patent application Ser. No. 12/330,390, filed Dec. 8, 2008 and entitled Light for Illuminating Plants, and U.S. patent application Ser. No. 12/236,501, filed Sep. 24, 2008 and entitled Light for Illuminating Plants. The disclosures of these patent applications are hereby incorporated by reference.

### TECHNICAL FIELD

The invention relates to flower pots including means for illuminating plants, plantings or the like.

### STATEMENT REGARDING FEDERALLY SPONSORED RESEARCH OR DEVELOPMENT

(Not applicable)

### BACKGROUND OF THE INVENTION

The dramatic effect of illuminated plants is well known. Spotlights are often used to accentuate architectural features, including plants, surrounding trees, and other visual aspects of structural arrangements and features.

Such lights take a wide variety of forms. For example, lights may comprise spotlights. Small area lights, often solar powered, are common architectural aspects of gardens. Sometimes lights are used in relatively specialized illumination applications, such as the use of strings of lights of the type commonly used to decorate Christmas trees and to wrap around and define the branches of trees which have lost their leaves during the holiday season.

Plants in pots lend a vibrant, relaxing and natural atmosphere to a space, whether it is indoor or outdoor. In the case of indoor plants, the same also have the good effect of increasing oxygen and humidity in the air. Plants may also trap air pollutants, rendering even further healthful effects.

Certainly one of the advantages of plants is the fact that they may be seen and, when seen, have the effect of psychologically relaxing people, as well as lending beauty and ambience to the space in which they are located.

However, modern lifestyles often mean work for long hours and arrival at home long after the sun has fallen. Thus, plants are not likely to be seen unless they are illuminated. However, given increasing fuel costs (which, in recent memory goes back certainly as far back as the early 1970s), environmental reasons to reduce consumption of electricity, and so forth, lights put on at night in a space may be task oriented, such as desk lamps or event oriented, such as a lamp on a coffee table which will only illuminate the area surrounded by a group of people talking, for example, at a cocktail party. There are also other circumstances which may restrict the amount of light available in the space, such as a room or patio, and these may include, for example, low levels of lighting used for economical reasons or to create a certain mood, and sometimes low levels of lighting associated with color lights also intended to create a mood.

Accordingly, plants located on a windowsill, for example, may not be sufficiently illuminated to be visible when lights in a room are turned on. Likewise, plants located in outdoor planting beds proximate to, for example, an open or closed patio, are not likely to be illuminated by general lighting.

However, the illumination of plants generally involves a separate lighting device. In my prior application I describe a device mounted on a spike adapted to be pushed into the earth in a flowerpot for the purpose of illuminating plants. However, placement of such a device in a pot where the plant is already large and dominating the space may be difficult. Likewise, if there is a need for a wide area of illumination, the positioning of multiple lighting devices within a pot may be problematic.

### SUMMARY OF THE INVENTION

In accordance with the invention, apparatus including structure for illuminating a plant is provided. A light is mounted on the housing. A control may turn the light on or off and/or otherwise control the light.

The inventive flowerpot may support a solar cell.

The light may be powered by a rechargeable battery.

A generator may be used to charge a rechargeable battery for powering the light.

Optionally the light output by the plant light may vary from one light color to another.

The light may be powered for a fixed period of time after the control is actuated.

In accordance with the invention, mechanics may be provided for variably controlling the position upon which light output from the light falls. The provision of a plurality of such light sources may be used to provide a desired illumination pattern. A control may optionally turn on the light in response to ambient light dropping below a predefined level.

More precisely, a flowerpot including structure for illuminating a plant or other object or objects contained within the flowerpot may comprise a container. At least one light is supported on the container. A power source is coupled to the at least one light.

The container may define an upper circumferential rim. The at least one light may be supported proximate the upper circumferential rim.

If desired, a plurality of lights may be disposed at spaced intervals about the circumferential rim.

The power source may be a rechargeable battery, and the inventive device may further comprise circuit structure associated with the rechargeable battery and the lights for preventing the lights from going on unless the rechargeable battery meets minimum performance criteria, whereby the rechargeable battery is unlikely to be completely discharged.

A generator may be provided for charging the rechargeable battery.

The light may vary from one light color to another.

The event of apparatus may further comprise a switch for actuating the coupling of power from the power source to the lights wherein the light may be powered for a fixed period of time after the switch is actuated.

The power source may be a rechargeable battery. The apparatus may further comprise circuit structure associated with the rechargeable battery and the lights for preventing the light from going on unless the rechargeable battery meets minimum performance criteria, whereby the rechargeable battery is unlikely to be completely discharged. In this embodiment, the rechargeable battery may be charged by a solar cell.

The lights may be mounted for rotation to achieve a desired illumination pattern.

The inventive apparatus may also comprise a solar activated switch for turning on the lights in response to ambient light dropping below a predefined level.

Each of the lights may comprise a fiber-optic output lens. The power source may be a light emitting device or devices, such as a light emitting diode. The light emitting device or devices may be coupled to the fiber optic output lens by a fiber optic member or bundle.

The inventive apparatus may further comprise a foam plastic member secured within the container. This allows an artificial plant or plants or cookies on sticks or other confections or other objects to be mounted in the foam plastic.

### BRIEF DESCRIPTION THE DRAWINGS

The operation of the invention will become apparent from the following description taken in conjunction with the drawings, in which:

FIG. 1 illustrates a perspective view of a flowerpot constructed in accordance the present invention;

FIG. 2 is a cross sectional view of the inventive plot showing the light illuminating structure;

FIG. 3 is a schematic diagram of the electrical circuit for the pot illustrated in FIG. 2 and constructed in accordance with the present invention;

FIG. 4 is a perspective view of a pot similar to the view of FIG. 1 and incorporating a solar source according to the present invention;

FIG. 5 is a detailed view of the solar source of the embodiment illustrated in FIG. 4;

FIG. 6 is a schematic diagram of a lighting circuit employed in the embodiment of FIG. 5;

FIG. 7 is a cross-sectional view of an alternative embodiment of the inventive lighted flowerpot incorporating a position adjustable light source;

FIG. 8 is a schematic cross-sectional view illustrating the operation of the light moving mechanism illustrated in FIG. 7 in accordance with the present invention with the light moved to a tilted position;

FIG. 9 is a schematic cross-sectional view illustrating the operation of the light moving mechanism illustrated in FIG. 7 in accordance with the present invention with the light moved to a more vertical position;

FIG. 10 is a schematic cross-sectional view illustrating the operation of the light moving mechanism illustrated in FIG. 7 in accordance with the present invention with the light moved to a position angularly displaced in a direction opposite that of the FIG. 8 position; and

FIG. 11 illustrates the lighted flowerpot of FIG. 7 in use;

FIG. 12 is a perspective view of an alternative embodiment of the present invention incorporating a crank for recharging;

FIG. 13 is a perspective view of the embodiment of FIG. 12 illustrating stowage of the crank after charging;

FIG. 14 is a perspective view of the inventive flowerpot with a foam plastic filler and various cookies and confections mounted in an arrangement in the manner of a flower arrangement; and

FIG. 15 is a schematic illustration of the inventive flashlight configured for fiber-optic transmission of light from a light source or sources to output lenses associated with the rim of the inventive flowerpot.

### DETAILED DESCRIPTION OF THE PREFERRED EMBODIMENTS

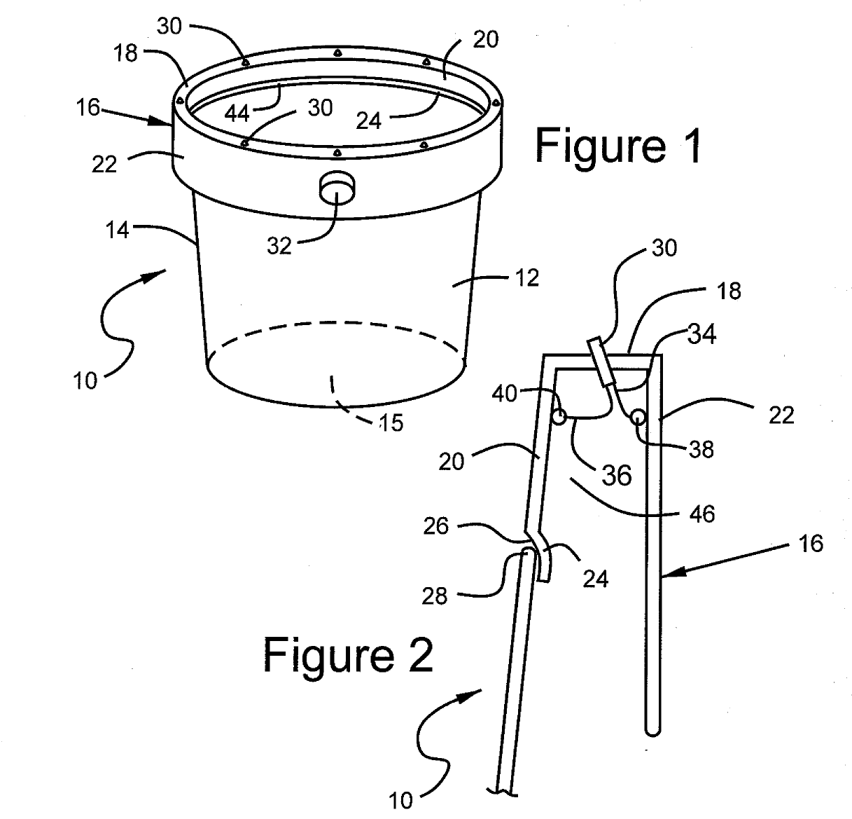

Referring to FIG. 1, the inventive lighted flowerpot 10 comprises a container 12 with a sidewall 14 and a bottom 15. As can be seen most clearly in FIG. 2, a lighted rim 16 is formed by an upper light supporting surface 18, an inner container engaging sidewall 20 and an outer rim 22. A lip 24 extends from and is formed integrally with inner container engaging sidewall 20.

Lip 24 defines an inner surface 26 which engages the top 28 of container sidewall 14. Inner surface 26 and top 28 of container sidewall 14 may define a snap fit whereby inner surface 26 and top 28 may be engaged during manufacture and remained together. Alternatively, inner surface 26 and top 28 may be held together using a suitable adhesive.

A plurality of lights 30 is disposed around the upper light supporting surface 18 of rim 16. Lights are turned on and off by a pushbutton switch 32. Lights 30 may comprise light emitting diodes or any suitable light source. Moreover, light emitting diodes 30 may be of any desired color, such as green, red, or may be color controllable comprising three or more or fewer light emitting members of, for example, different color, allowing them to be modulated (over time or in accordance with particular directions input by the user) in amplitude to vary overall color.

In accordance with a preferred embodiment of the invention, the inventive flowerpot 10 may be powered by any suitable source of power. The same may be a simple battery which may be rechargeable or nonrechargeable. It is also contemplated that flowerpot 10 may be powered by a rechargeable battery which is associated with a generator and recharging crank in the manner of a rechargeable flashlight.

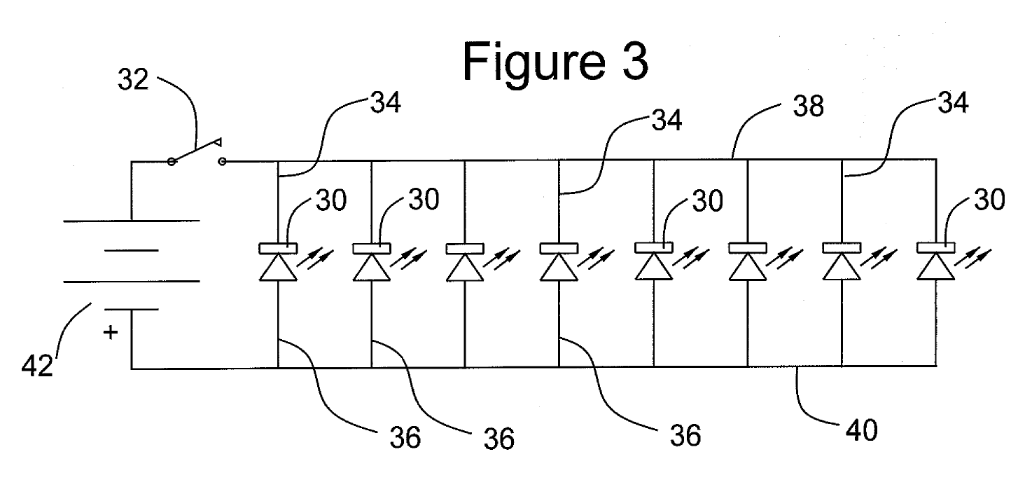

Referring to FIG. 3, light emitting diodes 30 receive power through leads 34 and 36. Leads 34 are connected to a conductor bus 38 by, for example, soldering or any suitable connection mechanism, such as crimping, welding or the like. Leads 36 are connected to a conductor bus 40.

Conductor bus 38 is, in turn, connected to switch 32. Switch 32 couples power from the negative terminal of a battery 42. Conductor bus 40 is connected directly to the opposite positive terminal of battery 42. Accordingly, when switch 32 is closed power is coupled to light emitting diodes 30, and illumination is provided to, for example, a plant located in pot 10.

In accordance with the invention, it is noted that the seam or joint formed at lip 24 should be positioned a relatively small difference from the top 28 of inventive pot 10. More particularly, it is contemplated that potting soil will be contained in pot 10 up to a level below the joint between lip 24 and or light supporting surface 18. Moreover, the upper level of such potting soil should be positioned below the joint 44 between lip 24 and/or light supporting surface 18 by a sufficient distance as to allow for rising water level during watering without water reaching the level of the joint between lip 24 and or light supporting surface 18. This ensures that spillage of excess water is minimized.

At the same time, the joint 44 between lip 24 and or light supporting surface 18 should be sufficiently low to allow most if not all of the major electrical components of the lighting circuit to be positioned in the space 46 at the upper end of lighted rim 16. This provides that in the event of a spill causing water to exit through joint 44 such water will enter space 46 and trip down without contacting the electrical components of the lighting circuit.

Container 12 and rim 16 may be made of any suitable material, such as plastic which has been injection molded, blow formed, or fabricated in any other fashion. If a different aesthetic or functional set of characteristics is desired, container 12 and rim 16 may be made of a more classical material, such as pottery, suitably treated wood, metal, wood lined with metal, and so forth.

Turning to FIG. 4, it may be seen that in accordance with the invention, an alternative power source may be used to implement the inventive lighted flowerpot 110. In the figures and/or description associated with this embodiment and in the other embodiments discussed below, parts performing analogous or similar functions may be numbered with numbers which are different from the analogous parts in the earlier embodiment and/or other earlier embodiments by multiples of a hundred, where this numbering convention is practical and convenient.

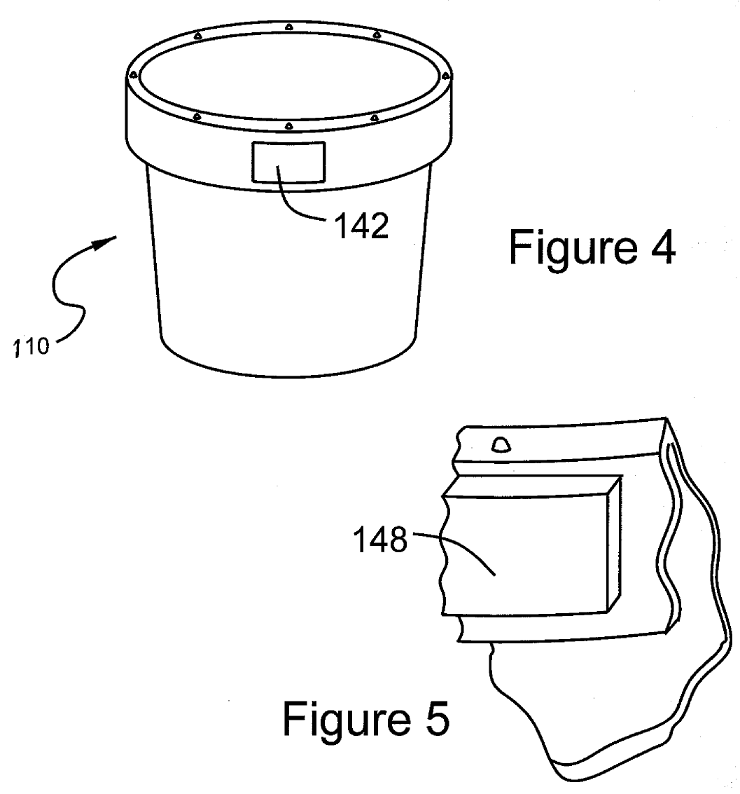

Referring to FIGS. 4-5, lighted flowerpot 110 is essentially the same as the embodiment illustrated in FIGS. 1-2, except that power is supplied by a solar cell 148. Solar cell 142 may be simply connected to receive light when available by suitably positioning the flowerpot 110 in an open window, or the like.

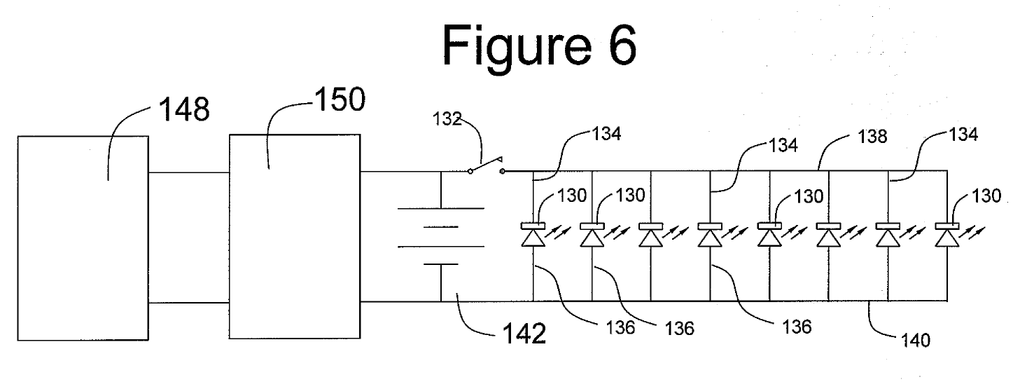

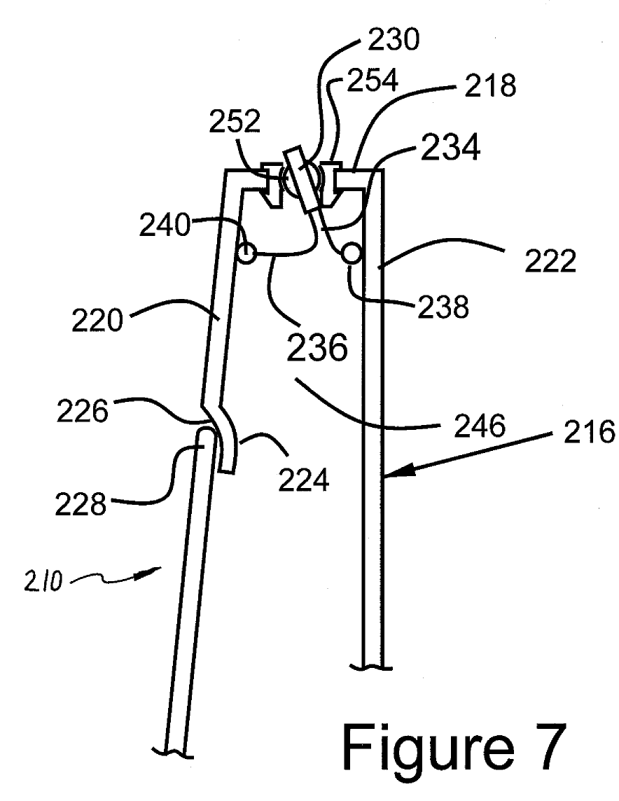

Referring to FIG. 6, a solar cell 148 charges a rechargeable battery 142 in a conventional matter to a recharging circuit 150. A switch 132 controls the turning on and turning off of light emitting diodes 130, coupled to the power circuitry by buses 138 and 140. Power may automatically be sent to light emitting diodes 130in response to a solar cell switch which detects that there is darkness. Such a solar cell activated switch may replace or be in addition to switch 132. Any other suitable ranges for turning on and turning off the lights, charging the rechargeable battery, and so forth as are detailed in the above-referenced priority applications may be employed. The disclosure of such priority applications is hereby incorporated by reference.

Referring to FIG. 7, a lighted flowerpot 210 constructed in accordance with the invention and incorporating position adjustable light emitting diode sources 230 is illustrated. In the embodiment of FIG. 7, the lights 230 mounted in lighted flowerpot 210 are supported by spherical supports 252 which are supported for ball and socket joint movement, said vertical supports 252 functioning as the “ball” part of the joint.

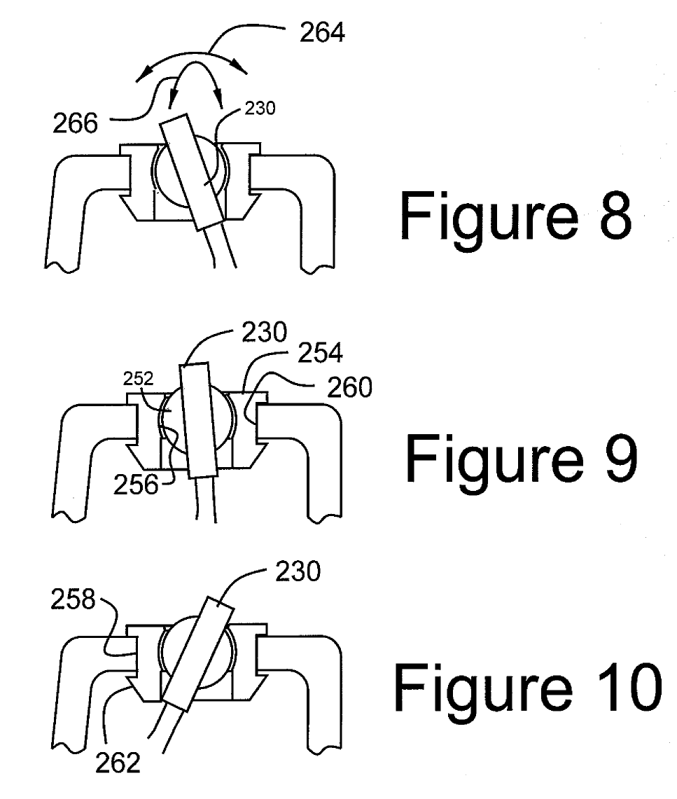

As may be seen most clearly in FIGS. 8-10 Each support 252 rotates within socket member 254 which has an inner spherical support surface 256. Socket member 254 also comprises an annular support groove 258, which engages circular hole 260 on rim 216. Socket member 254 may be snapped fit into hole 260 being driven into hole 260 by bringing conical ramp surface 262 into contact with hole 260 and applying pressure until hole 260 is in contact with annular support groove 258.

Light emitting diode 230 may be freely rotated in all directions with components in the radial direction 264 and in the tangential direction 266, thus allowing complete angular freedom of movement within the range of movement provided by the ball and socket joint formed by spherical support 252 and spherical support surface 256, which mates with the outside spherical surface of spherical support 252.

Accordingly, light emitting diodes 230 may be rotated from the radially inwardly directed position illustrated in FIG. 8, through a more upwardly directed position as illustrated in FIG. 9 and toward an outwardly directed position as illustrated in FIG. 10. In addition, that all of these positions and positions in between, the tilt may have a tangential component. This allows the light emitting diodes 232 illuminate any part of a plant within pot 210 that is within the range of moment of the ball and socket joint formed by spherical support 252 and spherical support surface 256.

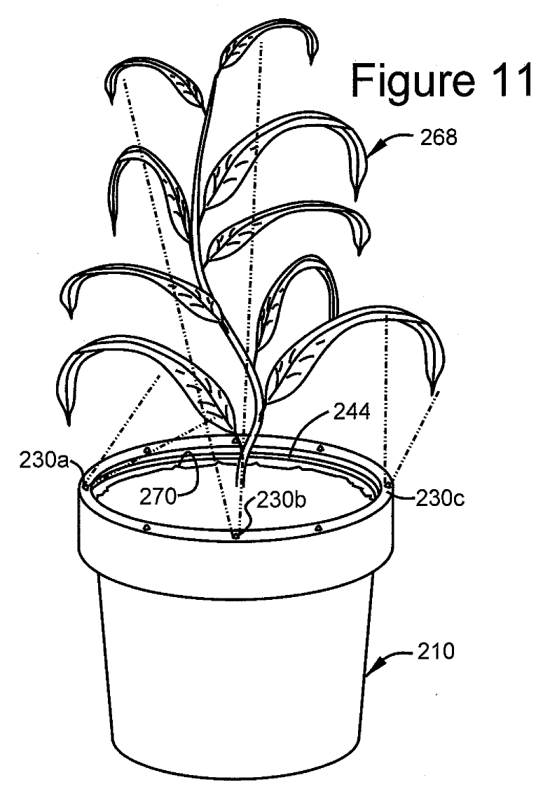

The possibilities for such a set of selectable illumination positions of, for example, a plant 268 is illustrated in FIG. 11. More particularly, light 230a may be adjusted to illuminate a lower radially inward portion of plant 268. Likewise, like emitting diode 230b may be adjusted to illuminate a central upward portion of plant 268. Light emitting diode 230c may be yet differently adjusted, and illuminating lower radially outward positions on plant 268.

As may be seen most clearly in FIG. 11, the top surface 270 of soil within pot 210 is positioned safely below joint 244. This allows water to be poured into pot 210 and rise to a level above the top surface 270 of the soil without reaching joint 244, thus ensuring that water will be retained in the pot and not leak, potentially causing damage.

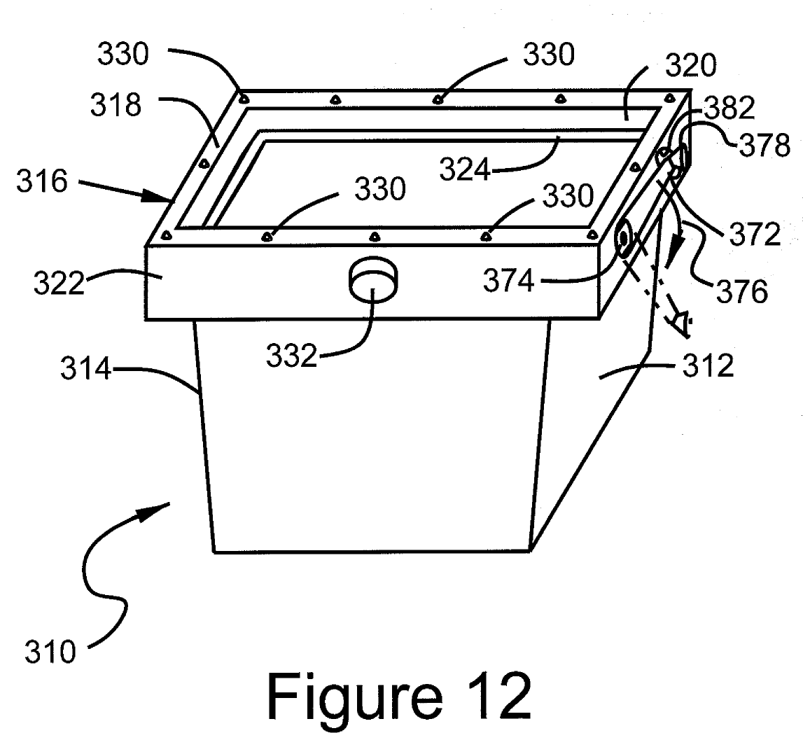

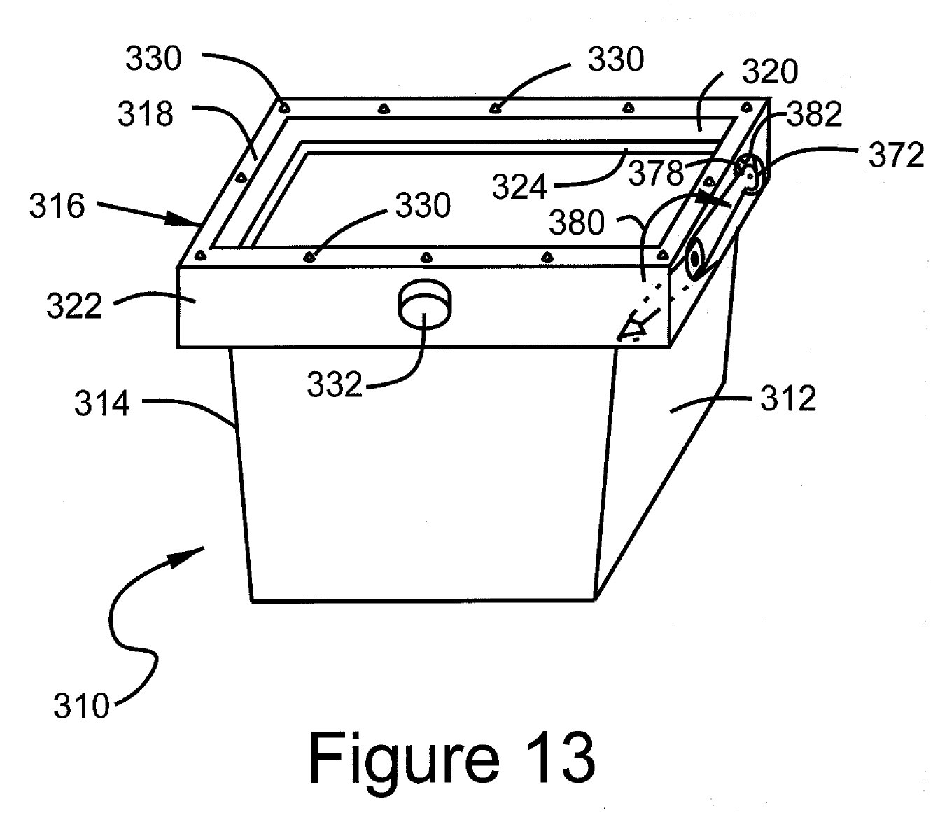

Referring to FIGS. 12-13, an alternative embodiment of the inventive pot 310 incorporating a generator mechanism for mechanically recharging the rechargeable battery light emitting diodes 330 is illustrated. The generator and associated mechanical assembly and electronic circuitry may be of the type conventionally incorporated in a crank flashlight. Such mechanisms are illustrated in the above-identified priority patent applications, the disclosures of which are hereby incorporated by reference.

More particularly, a crank 372 is mounted for rotation on an axle 374. Crank 372 may be moved in the direction of arrow 376, by grasping a knob 378, and cranking in a conventional fashion, for example in a clockwise direction. When cranking has been completed, crank 372 may be put in the position illustrated in phantom lines in and FIG. 13, after which it may be rotated in the direction of arrow 380 to the position illustrated in solid lines in FIG. 13. In this position, knob 378 is rotated into a well 382, in much the same manner as a conventional crank flashlight.

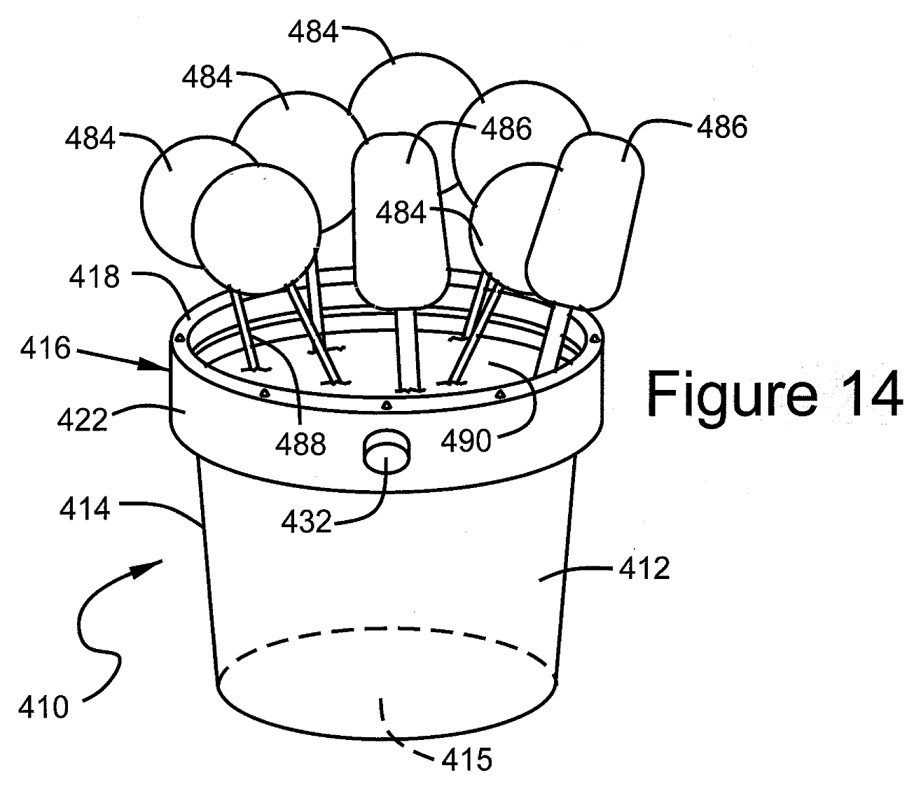

In accordance with the invention, it is noted that the inventive pot may be used to hold things other than living plants. For example, an artificial plant may be positioned within a pot or may be made a permanent part of the same. More creative applications may also be apparent to those of ordinary skill in the applicable art. For example, as may be seen with reference to FIG. 14, in recent years it has become fashionable to provide baked goods simulated to appear like an arrangement of flowers. The inventive pot 410 may contain cookies 484 and other baked goods, as well as ice cream pops 486 on sticks 488 arranged in the inventive pot and made to look like a flowerpot with a living plant or plants, or bouquet arrangement. Such baked goods may also be illuminated in accordance with the present invention using any one of the structures disclosed herein.

Implementation of such non-living plant type applications is achieved in accordance with the present invention by providing a solid foam plastic 490, such as Styrofoam brand foam plastic, filler member whose shape generally matches or snugly may be secured within the inside of pot 410. Such confections, such as cookies 484, ice cream pops 486, or the like may be inserted in the foam plastic member 490. In this manner, they are secured in a stable configuration and lighted, as desired in accordance with the features of any of the embodiments disclosed herein.

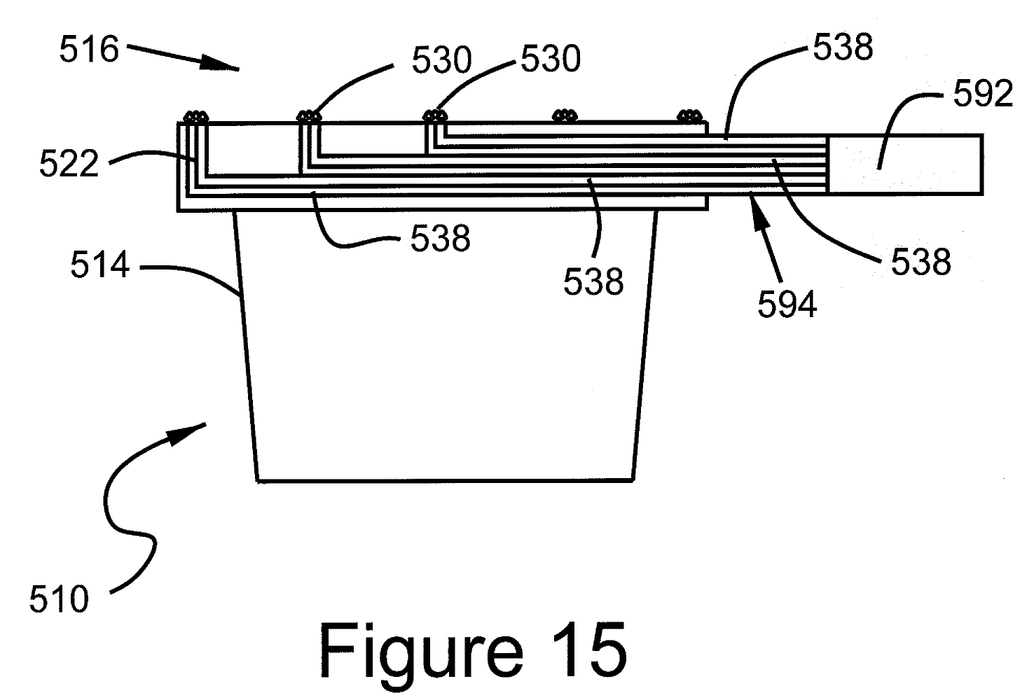

Referring to FIG. 15, a pot 510 constructed in accordance with the present invention may comprise a single light source 592 or a plurality of light sources. In this figure, only the fiber optics associated with some of the lenses which serve as fiber optic light outputs are illustrated for purposes of clarity of illustration. However, it will be understood that as many light output points as are desired on the rim of the pot may be provided with fiber optic fibers or bundles for the purpose of providing illumination as desired. The light source or sources may driven by a fiber-optic bundle 594, with individual fibers 538 or fiber groups ending at the positions where they are coupled to output lenses 530. In the illustrated embodiment, each of the light emitting diodes 30 of the FIG. 1 embodiment is replaced by a cluster of three output lenses 530, which may be selected to give the appearance of a substantially complete (or at least greatly varied) spectrum of color, for example cyan, yellow and magenta. This may be achieved by varying the relative proportion of power sent to each of the light sources of different color. These light sources may be light emitting diodes or other light emitting sources.

While no structure has been shown for the alteration of the output angle of light from the lenses in the embodiment of FIG. 15, it is noted that in accordance with an alternative embodiment, the ends of the fiber-optic bundles may be glued to the input face of the output lenses and the entire assembly rotated by an appropriate mechanical mechanism.

While illustrative embodiments of the invention have been described, it is understood that modifications will be obvious to those of ordinary skill in the art. Such modifications are within the spirit and scope of the invention which is limited and defined only by the appended claims.

What is claimed is:

1. A flowerpot including structure for illuminating a plant or other object or objects contained within said flowerpot, comprising:
(a) a container;
(b) at least one light supported on said container; and
(c) power source coupled to said at least one light.

2. Apparatus as in claim 1, wherein said container defines an upper circumferential rim, and said at least one light is supported proximate said upper circumferential rim.

3. Apparatus as in claim 2, wherein a plurality of lights are disposed at spaced intervals about said circumferential rim.

4. Apparatus as in claim 3, wherein said power source is a rechargeable battery, and further comprising circuit structure associated with said rechargeable battery and said lights for preventing said light from going on unless said rechargeable battery meets minimum performance criteria, whereby said rechargeable battery is unlikely to be completely discharged.

5. Apparatus as in claim 4, further comprising a generator for charging said rechargeable battery.

6. Apparatus as in claim 3, wherein said light varies from one light color to another.

7. Apparatus as in claim 3, further comprising a switch for actuating of the coupling of power from said power source to said lights wherein said light is powered for a fixed period of time after said switch is actuated.

8. Apparatus as in claim 3, wherein said power source is a rechargeable battery, and further comprising circuit structure associated with said rechargeable battery and said lights for preventing said light from going on unless said rechargeable battery meets minimum performance criteria, whereby said rechargeable battery is unlikely to be completely discharged, and wherein said rechargeable battery is charged by a solar cell.

9. Apparatus as in claim 3, wherein said lights are mounted for rotation to achieve a desired illumination pattern.

10. Apparatus as in claim 3 further comprising solar cell activated switch for turning on said lights in response to ambient light dropping below a predefined level.

11. Apparatus as in claim 3, wherein each of said lights comprises a fiber-optic output lens and wherein said power source is a light emitting device or devices, and said light emitting device or devices are coupled to said fiber optic output plans by a fiber optic member or bundle.

12. Apparatus as in claim 3, wherein each of said lights comprises a light emitting diode.

13. Apparatus as in claim 3, further comprising a foam plastic member secured within said container and wherein an artificial plant or plants or cookies on sticks or other confections or other objects are mounted in said foam plastic.

14. Apparatus as in claim 3, wherein each of said lights comprises a cluster of three lenses, each of said three lenses corresponding to one of three different colors, said three colors being a first color, a second color and a third color, wherein a power source comprising a light emitting device is associated with each of said colors, each power source emitting light of its respective color and wherein all of the lenses corresponding to said first color are coupled by fiber optics to their respective lenses associated with said first color, all of the lenses corresponding to said second color are coupled by fiber optics to their respective lenses associated with said second color and all of the lenses corresponding to said third color are coupled by fiber optics to their respective lenses associated with said third color.

15. Apparatus as in claim 3, wherein the power source is a rechargeable battery and further comprising a solar cell for charging said rechargeable battery.
